(19) United States
(12) Patent Application Publication
(10) Pub. No.: US 2014/0123834 A1
(43) Pub. Date: May 8, 2014

(54) Automated Music Displaying System for Musical Instrument

(71) Applicant: Shenzhen SiYiRui Technology Co., Ltd., Shenzhen (CN)

(72) Inventor: Wenyu WANG, Shenzhen (CN)

(73) Assignee: Shenzhen SiYiRui Technology Co., Ltd., Shenzhen (CN)

(21) Appl. No.: 14/074,388

(22) Filed: Nov. 7, 2013

(30) Foreign Application Priority Data
Nov. 7, 2012 (CN) 201220590010.1

(51) Int. Cl. B42D 9/04

(52) U.S. Cl. CPC B42D 9/04
USPC 84/486

(57) ABSTRACT

An automated music displaying system includes a displaying device, a main processing module electrically connecting to the displaying device for driving the displaying device to display a predetermined page of a music sheet in electronic format, and a stepping actuator electrically connecting to the main processing module, wherein when the stepping actuator is actuated, the stepping actuator is arranged to send a signal to the main processing module for driving the displaying device to change a display of a page of sheet music.

### BACKGROUND OF THE PRESENT INVENTION

1. Field of Invention

The present invention relates to a musical instrument, and more particularly to an automated music displaying system comprising a display which is capable of displaying the content of a song book or sheet music in an electronic format corresponding to the actual progress of a performance of the musical instrument.

2. Description of Related Arts

A conventional song book or sheet music usually comprises a plurality of papers bound together to form a book. The papers are printed with many lyrics or chords for allowing a reader to follow during practice or in a performance. For example, in a typical piano performance, sheet music bounded as a book may be placed in front of the performer and during the course of the performance, an assistant may sit next to the performer and help him or her to turn over the pages of the song book or sheet music for allowing the performer to follow the progress of a particular song or music.

Obviously, this traditional practice concerning piano performances is highly inconvenient on the part of the performer, and may actually affect the piano performance as a whole. For example, if the assistant makes any error or delays in turning over pages, the rhythms of the song or the performance as a whole will be adversely affected. At the same time, one may appreciate that in this traditional setting of piano performance, the performer has no way to turn the pages by himself or herself in a performance. This is because the performer must use both hands to operate the piano continuously for achieving a continuous and high quality performance.

### SUMMARY OF THE PRESENT INVENTION

An objective of the present invention is to provide an automated music displaying system comprising a display which is capable of displaying the content of a song book or sheet music corresponding to the actual progress of a performance of the musical instrument, such as in a piano performance.

Another objective of the present invention is to provide an automated music displaying system, wherein the display may be conveniently positioned on the musical instrument for allowing the performer to actuate turning of song book or sheet music pages shown on the display.

Another objective of the present invention is to provide an automated music displaying system which comprises a stepping actuator for allowing a performer to actuate turning of song book or sheet music pages by stepping onto the stepping actuator. In other words, the performer does not need an assistant to turn over pages for him.

In one aspect of the present invention, it provides an automated music displaying system, comprising:

a displaying device;

a main processing module electrically connecting to the displaying device for driving the displaying device to display a predetermined page of sheet music in electronic format; and

a stepping actuator electrically connecting to the main processing module, wherein when the stepping actuator is actuated, the stepping actuator is arranged to send a signal to the main processing module for driving the displaying device to turn over the page of the sheet music.

### BRIEF DESCRIPTION OF THE DRAWINGS

FIG. 1A is an overall schematic block diagram of an automatic music displaying system according to a preferred embodiment of the present invention.

FIG. 1B is a schematic block diagram of a stepping actuator of the automatic music displaying system according to the preferred embodiment of the present invention.

FIG. 2 is an exploded perspective view of a stepping actuator of the automatic music displaying system according to the preferred embodiment of the present invention.

FIG. 3 is a schematic diagram of the automatic music displaying system according to the preferred embodiment of the present invention, illustrating the interaction between a displaying device and the stepping actuator.

FIG. 4A to FIG. 4B are circuit diagrams of the automatic music displaying system according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

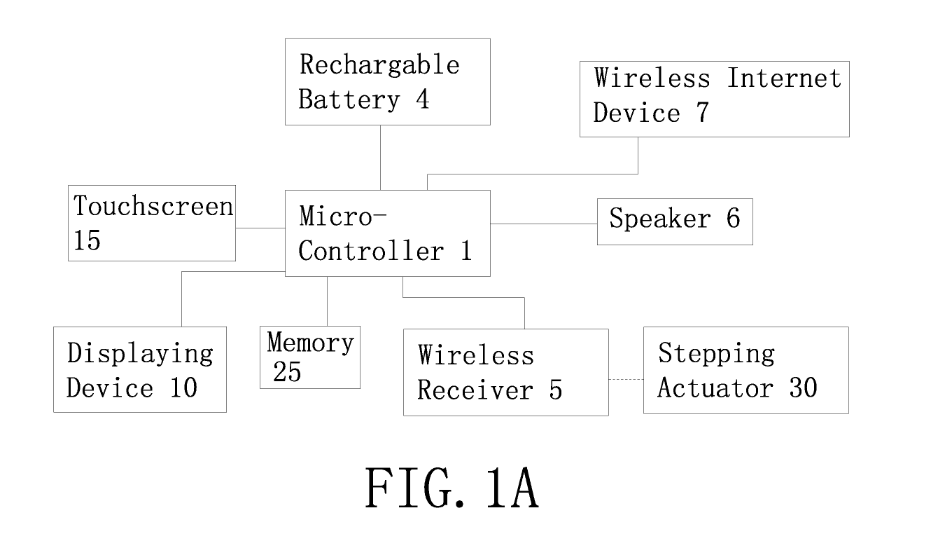

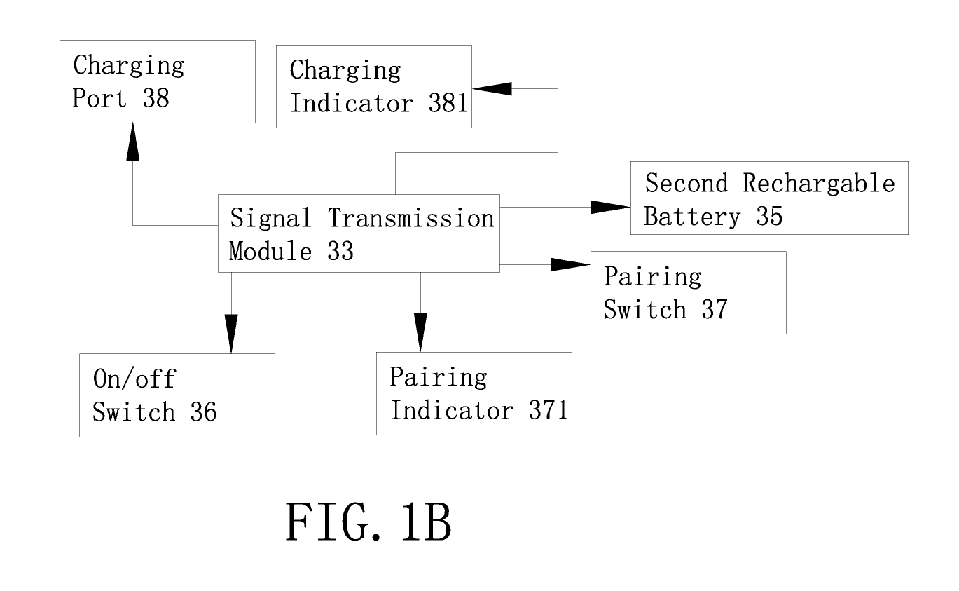

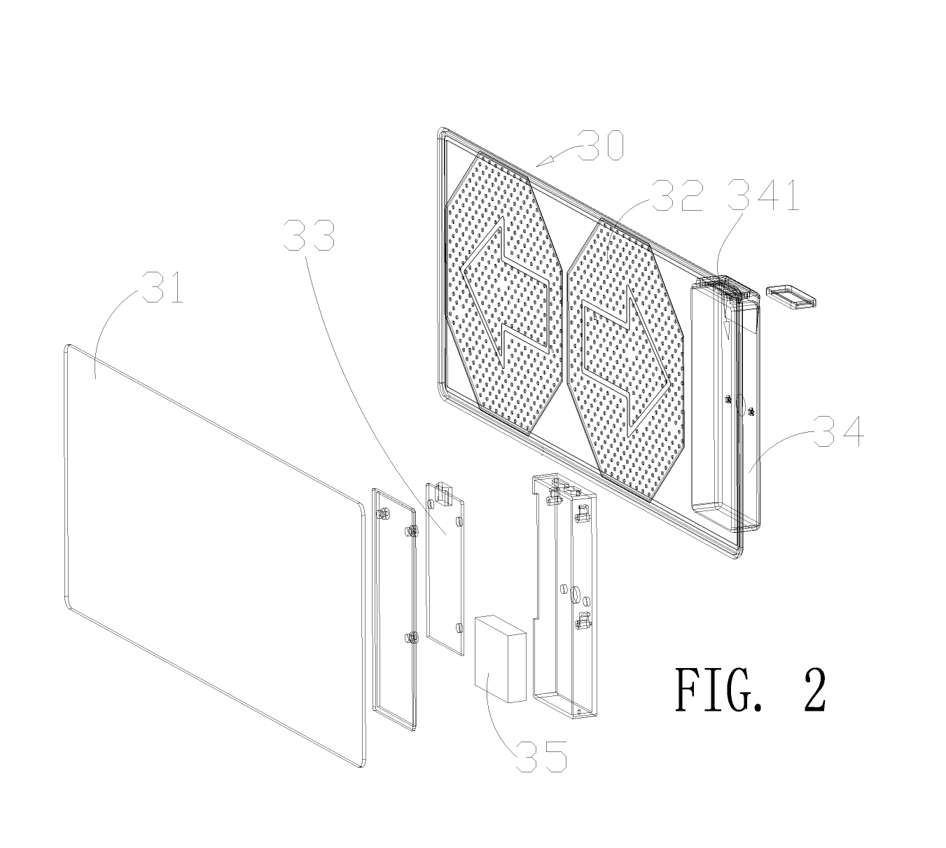

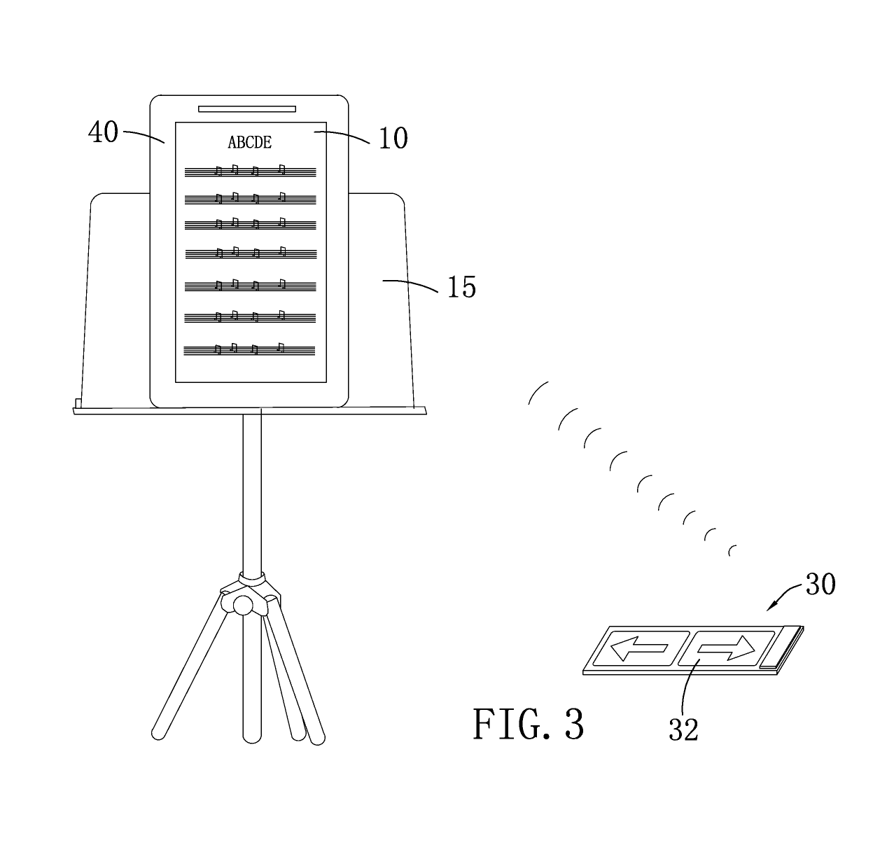

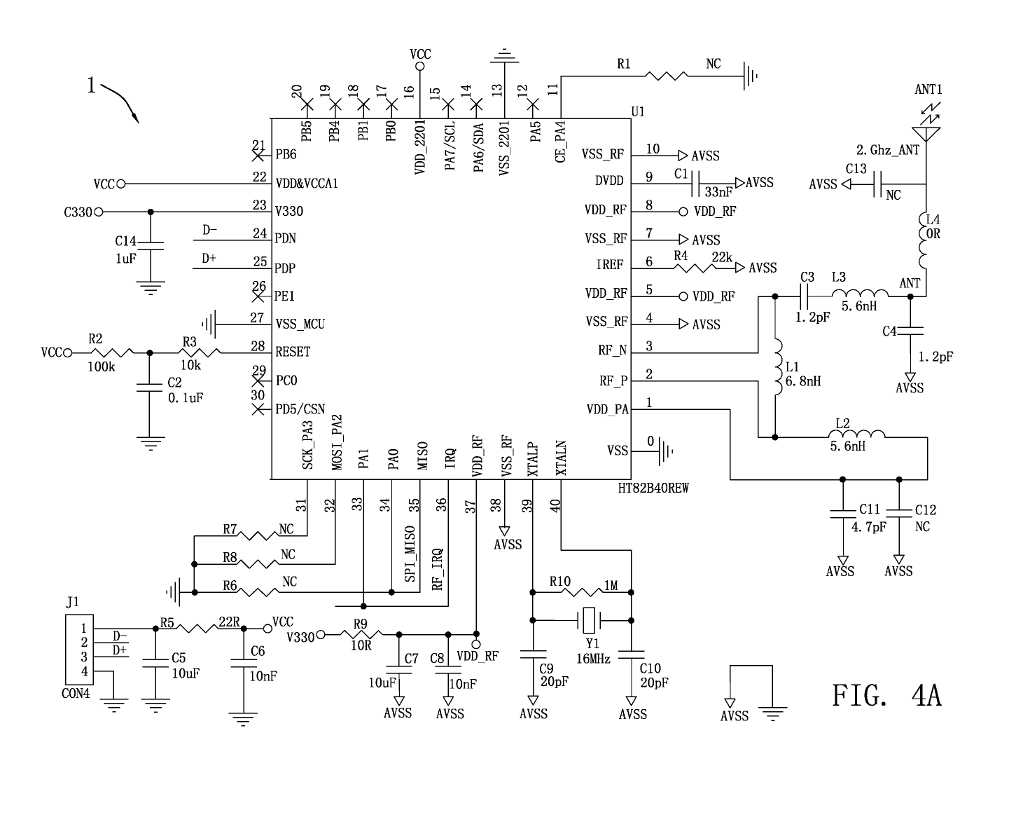

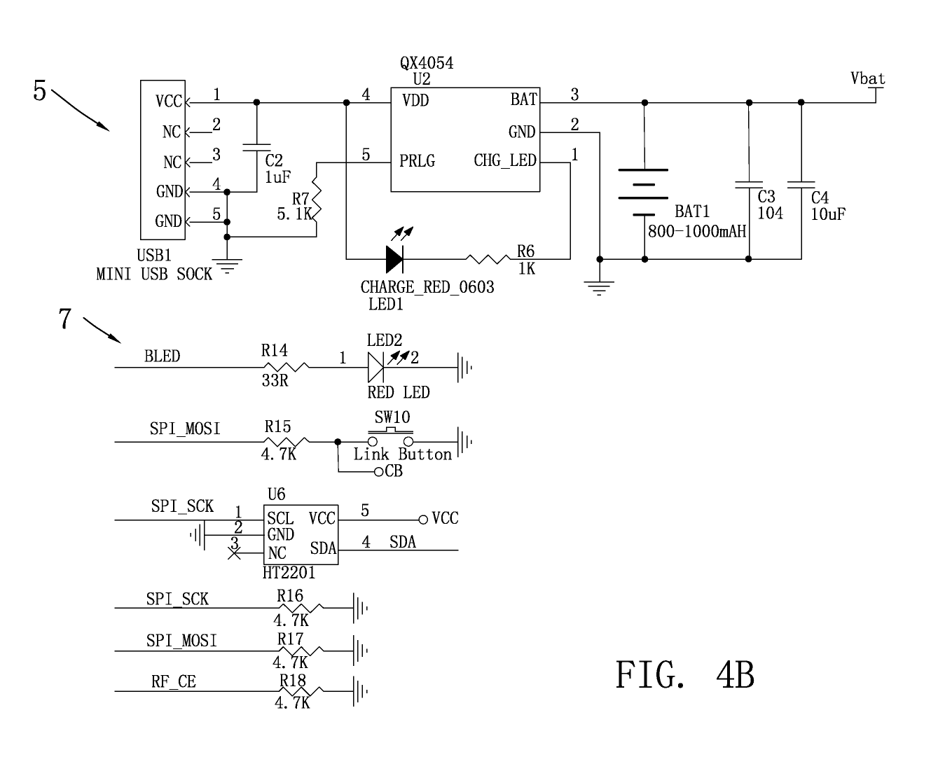

Referring to FIG. 1A, FIG. 1B, FIG. 2 to FIG. 3, and FIG. 4A to FIG. 4B of the drawings, an automated music displaying system according to a preferred embodiment of the present invention is illustrated. Broadly, the automated music displaying system comprises a displaying device 10, a main processing module 20, and a stepping actuator 30.

The automated music displaying system is for use in conjunction with a musical instrument, such as a piano. In a typical piano performance, the performer must use both of his or her hands to operate the piano. As such, the automated music displaying system of the present invention allows the performer to follow a predetermined sheet music or song book without requiring an assistant to manually turn over physical pages during a performance or practice session. It is worth mentioning that the automated music displaying system of the present invention may also be used in conjunction with other types of musical instruments and these applications are also covered within the spirit of the present invention.

The displaying device 10 and the main processing module 20 may be incorporated into a single computing device, such as a tablet computer as shown in FIG. 3 of the drawings. However, these two components can be separately provided. Moreover, they may be electrically connected in a wired or wireless manner.

The displaying device 10 may be equipped with a touchscreen or a regular non-touch screen. The displaying device 10 is arranged to display a particular page of a predetermined sheet music or song book in an electronic format. Each page of the sheet music or the song book may contain a plurality of lyrics and/or chords which constitute part of an entire music or song. The displaying device 10 has a predetermined resolution and may display a color image or a black-and-white image.

The main processing module 20 is electrically connected to the displaying device 10 for driving the displaying device 10 to display a page of a predetermined sheet music or song book in electronic format.

The stepping actuator 30 is electrically connected to the main processing module 20, wherein when the stepping actuator 30 is actuated, the stepping actuator 30 is arranged to send a signal to the main processing module 20 for driving the displaying device 10 to display a subsequent page of the sheet music or the song book. The effect of displaying a subsequent page of the sheet music or the song book is to resemble turning over the pages of the sheet music or the song book so that the performer may continuously follow the lyrics and chords of music or a song without interruption.

According to the preferred embodiment of the present invention, the automated music displaying system further comprises a housing 40 accommodating the displaying device 10 and the main processing module 20. The housing 40 may be configured as resembling the housing of a tablet computer, while the displaying device 10 is preferably configured as having a touchscreen 15 for allowing the user to input predetermined commands to the main processing module 20. Thus, the housing 40 may be placed at a suitable position on the musical instrument so that the performer may visually observe the displaying device 10 while sitting in front of the musical instrument, as shown in FIG. 3 of the drawings.

As shown in FIG. 1A and FIG. 4A of the drawings, the main processing module 20 comprises a microcontroller 1, a wireless receiver 5 electrically connecting to the microcontroller 1, and a wireless Internet device 7 electrically connecting to the microcontroller 1 for wirelessly accessing to Internet. The microcontroller 1 is for processing digital signals in displaying pages of the sheet music or the song book in electronic format by the displaying device 10, and for processing the actuation signal generated by the stepping actuator 30. The circuit diagram of the microcontroller 1 is shown in FIG. 4A of the drawings. The circuit diagram of the wireless receiver 5 and the wireless Internet device 7 is shown in FIG. 4B of the drawings.

The automated song book system further comprises a speaker 6 providing on the housing 10 and is electrically connected to the main processing module 20, and a rechargeable battery 4 received in the housing 10 and is arranged to electrically connect to the main processing module 20. Thus, the housing 40, the displaying device 10, and the main processing module 20 may form a stand-along computing unit which can access to the Internet and can be placed on the musical instrument and is powered by the rechargeable battery 4.

In order to support more functions, the main processing module 20 further comprises a memory 25 providing in the housing 40 and is electrically connected to the microcontroller 1 for storing data. Thus, sheet music and song books in electronic formats may be pre-loaded and stored in the memory 25.

On the other hand, as shown in FIG. 1B, FIG. 2 and FIG. 4B of the drawings, the stepping actuator 30 comprises a main body 31, a plurality of actuating pedals 32 operatively provided on the main body 31, and a signal transmission module 33 providing in the main body 31 and electrically connecting to the actuating pedals 32, in such a manner that when at least one of the actuating pedals 32 is actuated, the signal transmission module 33 is arranged to send a corresponding signal to the main processing module 20. For example, when one of the actuating pedals 32 is stepped on by the performer, the signal transmission module 33 is arranged to send a signal to the main procession module 20, in which the microcontroller 1 is arranged to command the displaying device 10 to display a subsequent page of the predetermined sheet music or song book. The practical effect of this change in display is that the page of the sheet music or song book is turned over so that a new page of lyrics and chords can be displayed for allowing the performer to continue performing.

The main body 31 of the stepping actuator 30 is preferably configured from a material having a high coefficient of friction and relatively soft (such as silicon rubber) so that when the stepping actuator 30 is placed on the ground and is stepped on by the performer, the position of the stepping actuator 30 can be retained by the friction between the stepping actuator 30 and the ground surface.

The actuating pedals 32 are provided on the main body 31 in such a manner that when the actuating pedals 32 are actuated, minimal sound will be generated as a result of the actuation. This feature prevents the operation of the actuating pedals 32 from generating any noticeable sound which may interfere with the performance of the performer. Thus, when the actuating pedals 32 are stepped on, the signal transmission module 33 will be actuated without any noticeable sound generated by the actuating pedals 32. Furthermore, the soft structure provided by the actuating pedals 32 and the main body 33 allows the stepping actuator 30 to be extremely portable and easily set up.

It is worth mentioning that the connection between the stepping actuator 30 and the main processing module 20 may be wired or wireless. In the former case, the stepping actuator 30 and the main processing module 20 may be connected through a USB cable and USB ports provided on the housing 40 and the stepping actuator 30 respectively. In the latter case, the signal transmission module 33 of the stepping actuator 30 may be in wireless communication with the wireless receiver 5 of the main processing module 20 so that the actuation signal generated by the signal transmission module 33 can be received by the wireless receiver 5. The actuation signal commands changing of sheet music or song book pages on the displaying device 10.

According to the preferred embodiment of the present invention, the stepping actuator 30 comprises two actuating pedals 32 for indicating two directions to which a song book page will be turned. For example, one of the actuating pedals 32 may indicate turning of a song book page in a forward direction, while another actuating pedals 32 may indicate turning of a song book page in a backward direction.

The stepping actuator 30 further comprises a storage housing 34 defining a storage compartment 341 on the main body 31, wherein the signal transmission module 33 is received in the storage compartment 341. Moreover, the stepping actuator 30 further comprises a second rechargeable battery 35 received in the storage compartment 341 and is electrically connected to the signal transmission module 33. The second rechargeable battery 35 is responsible for providing power to operate the stepping actuator 30. The stepping actuators 30 may further comprise an on-off switch 36, a pairing switch 37, a pairing indicator 371, a charging port 38, and a charging indicator 381. These are all electrically connected to the signal transmission module 33.

The wireless transmission between the signal transmission module 33 and the main processing module 20 which may be accommodated in the housing 40 may be accomplished through RF signal transmission, BLUETOOTH transmission technology, or other wireless communication technologies.

The operation of the present invention is as follows: the housing 40 accommodating the displaying device 10 and the main processing module 20 are positioned on the musical instrument such as the piano as described above. The displaying device 10 may be put at a position which can easily be observed by a performer during a performance. For example, the displaying device 10 may be supported at eye-level of the performer. The stepping actuator 30, on the other hand, may be placed at the ground and in the vicinity of the performer's foot.

When the performer is performing, the displaying device 10 is arranged to display a particular page of a pre-loaded sheet music or song book. He or she may then follow the lyrics or chords of that particular page. However, when that page is finished, the performer may step on one of the actuating pedals 32. This stepping motion actuates the signal transmission module 33 which transmits a signal to the main processing unit 20 in a wired or wireless manner. The main processing unit 20 will then command the displaying unit 10 to display another page of the sheet music or the song book.

Alternatively, the automated music displaying system has another mode of operation. The main processing module 20 is arranged to initiate continuous movement or rolling of the pages of the sheet music or song book at a predetermined speed. In this situation, when the performer steps on the actuating pedals 32, the continuous movement of the pages of the sheet music or the song book stops. When the performer's foot moves away from the actuating pedals 32, the movement of the pages of the sheet music or the song book continues. When the speed at which the pages of the sheet music or the song book moves is optimally controlled, the performer needs not actuate turning over of sheet music or song book pages. He or she only needs to initiate freezing or stopping of the electronic display of the sheet music or song book page.

The present invention, while illustrated and described in terms of a preferred embodiment and several alternatives, is not limited to the particular description contained in this specification. Additional alternative or equivalent components could also be used to practice the present invention.

What is claimed is:

1. An automated music displaying system, comprising:
a displaying device;
a main processing module electrically connecting to said displaying device for driving said displaying device to display a predetermined page of sheet music in electronic format; and
a stepping actuator electrically connecting to said main processing module, wherein when said stepping actuator is actuated, said stepping actuator is arranged to send a signal to said main processing module for driving said displaying device to actuate a change of display of said sheet music.

2. The automated music displaying system, as recited in claim 1, wherein said main processing module is arranged to drive said displaying device to display a change of page of said sheet music when said stepping actuator is actuated.

3. The automated music displaying system, as recited in claim 1, wherein said main processing module is arranged to drive said displaying device to display said sheet music in a continuously rolling manner, wherein when said stepping actuator is actuated, said movement of said page of said sheet music is arranged to stop.

4. The automated music displaying system, as recited in claim 2, further comprising a housing accommodating said displaying device and said main processing module, wherein said housing is configured as a having a shape of a tablet computer.

5. The automated music displaying system, as recited in claim 3, further comprising a housing accommodating said displaying device and said main processing module, wherein said housing is configured as a having a shape of a tablet computer.

6. The automated music displaying system, as recited in claim 4, wherein said main processing module comprises a microcontroller, a wireless receiver electrically connecting to said microcontroller for receiving wireless signals from said wireless receiver.

7. The automated music displaying system, as recited in claim 5, wherein said main processing module comprises a microcontroller, a wireless receiver electrically connecting to said microcontroller for receiving wireless signals from said wireless receiver.

8. The automated music displaying system, as recited in claim 6, further comprising a speaker provided on said housing and is electrically connected to said main processing module, and a rechargeable battery received in said housing and is arranged to electrically connect to said main processing module, so that said housing, said displaying device, and said main processing module form a stand-along unit and is configured to be placed on a musical instrument.

9. The automated music displaying system, as recited in claim 7, further comprising a speaker provided on said housing and is electrically connected to said main processing module, and a rechargeable battery received in said housing and is arranged to electrically connect to said main processing module, so that said housing, said displaying device, and said main processing module form a stand-along unit and is configured to be placed on a musical instrument.

10. The automated music displaying system, as recited in claim 8, wherein said main processing module further comprises a memory being mounted in said housing and is electrically connecting to said microcontroller for storing music and song data.

11. The automated music displaying system, as recited in claim 9, wherein said main processing module further comprises a memory being mounted in said housing and is electrically connecting to said microcontroller for storing music and song data.

12. The automated music displaying system, as recited in claim 2, wherein said stepping actuator comprises a main body, a plurality of actuating pedals operatively providing on said main body, and a signal transmission module supported by said main body and electrically connecting to said actuating pedals, in such a manner that when at least one of said actuating pedals is actuated, said signal transmission module is arranged to send a corresponding signal to said main processing module for changing said display shown on said displaying device.

13. The automated music displaying system, as recited in claim 3, wherein said stepping actuator comprises a main body, a plurality of actuating pedals operatively providing on said main body, and a signal transmission module supported by said main body and electrically connecting to said actuating pedals, in such a manner that when at least one of said actuating pedals is actuated, said signal transmission module is arranged to send a corresponding signal to said main processing module for changing said display shown on said displaying device.

14. The automated music displaying system, as recited in claim 11, wherein said stepping actuator comprises a main body, a plurality of actuating pedals operatively providing on said main body, and a signal transmission module supported by said main body and electrically connecting to said actuating pedals, in such a manner that when at least one of said actuating pedals is actuated, said signal transmission module is arranged to send a corresponding signal to said main processing module for changing said display shown on said displaying device.

15. The automated music displaying system, as recited in claim 12, wherein said main body of said stepping actuator is configured from a soft and flexible material while having a high coefficient of friction.

16. The automated music displaying system, as recited in claim 13, wherein said main body of said stepping actuator is configured from a soft and flexible material while having a high coefficient of friction.

17. The automated music displaying system, as recited in claim 14, wherein said main body of said stepping actuator is configured from a soft and flexible material while having a high coefficient of friction.

18. The automated music displaying system, as recited in claim 15, wherein said stepping actuator comprises two actuating pedals for indicating a direction to which said page of said sheet music is turned as shown on said displaying device.

19. The automated music displaying system, as recited in claim 16, wherein said stepping actuator comprises two actuating pedals for indicating a direction to which said page of said sheet music is turned as shown on said displaying device.

20. The automated music displaying system, as recited in claim 17, wherein said stepping actuator comprises two actuating pedals for indicating a direction to which said page of said sheet music is turned as shown on said displaying device.
